(19) United States
(12) Patent Application Publication
(10) Pub. No.: US 2015/0251272 A1
(43) Pub. Date: Sep. 10, 2015

(54) Device for position control of a laser machining beam

(71) Applicant: LPKF LASER & ELECTRONICS AG, Garbsen (DE)

(72) Inventors: Manuel Sieben, Furth-Vach (DE); Andreas Bönke, Hannover (DE); Jan Van Aalst, Barsinghausen (DE)

(21) Appl. No.: 14/429,863

(22) PCT Filed: Aug. 26, 2013
(86) PCT No.: PCT/EP2013/067647

§ 371 Date: Mar. 20, 2015

(30) Foreign Application Priority Data
Sep. 21, 2012 (DE) 10 2012 217 081.2

(51) Int. Cl. B23K 26/04; B23K 26/03; B29C 67/00; B29C 65/16; B29C 65/00

(52) U.S. Cl. CPC B23K 26/041; B29C 65/16; B29C 66/95; B29C 66/836; B29C 67/00; B23K 26/032; B29L 2009/00

(57) ABSTRACT

A device for the position control of a laser machining beam relative to topographical structural markers in surfaces of workpieces, includes a control mechanism, a laser beam feed mechanism for providing a laser machining beam, and a laser beam positioning mechanism, and an optical recognition mechanism for the structural markers with an illumination mechanism for producing a parallel beam bundle, which illuminates the surface with the structural markers to be recognized in a scanning field, and a camera detecting the scanning field for recording the beam bundle, which is reflected by the surface and changed by the structural markers, wherein the camera image can be evaluated by the control mechanism to recognize the position of the structural markers and for the corresponding position control of the laser machining beam.

### CROSS-REFERENCES TO RELATED APPLICATIONS

This application claims the priority of German Patent Application, Serial No. 10 2012 217 081.2, filed Sep. 21, 2012, pursuant to 35 U.S.C. 119(a)-(d), the content of which is incorporated herein by reference in its entirety as if fully set forth herein.

### FIELD

The invention relates to a device for the position control of a laser machining beam relative to topographical structural markers, in particular of depressions, in surfaces of workpieces.

### BACKGROUND

Known basic components in laser machining systems, such as are also provided in the device according to the invention for the position control of a laser machining beam, are, a control mechanism, a laser beam feed mechanism for providing a laser machining beam and a laser beam positioning mechanism controlled by the control mechanism for the position control of the laser machining beam on workpiece surfaces relative to the structural markers mentioned at the outset.

With respect to the background of the invention, microfluidics is to be mentioned as a typical application area, in which plastics material components with internal, microscopically small channels are used. These microfluidic components themselves generally consist here of a lower plate, in the surface of which, as the base body, the required microscopically small channels are introduced for guiding, for example, analysis liquids. An upper, flat plate is placed as a lid on this lower plate.

The two plates are generally permanently connected to one another by means of thermobonding, UV-bonding or by means of a mask welding technique.

In thermobonding, the two plates are heated over the whole area. The temperature used is selected in such a way that the materials involved soften. The two join partners are then positioned on one another and the two plates are pressed. As the contact face of the two components is very large in relation to the channel structures, a squeezing melt flow caused by the pressing can block channels or deform the wall thereof.

In UV-bonding, an adhesive film is applied in a thin layer to one side of the plates. After the two plates have been joined, the adhesive is cured over the whole area by means of UV light. There is also a danger in this method that adhesive will penetrate into the channel structure leading to blockages within the microfluidics.

A relevant prior art is represented by the known mask welding according to EP 0 997 261 A1, a linear laser beam being guided over a mask. The laser beam enters through the uncovered mask regions, a weld seam being produced at these points on the component, for example by known transmission welding. However, this device requires a product-specific mask, the contour of which cannot be changed or adapted. Furthermore, a specific spacing exists between the mask and component and the parallelism of the beam bundle is also limited. Overall, this leads to the fact that the sharpness of the edges of the weld seams thus being formed, and therefore the degree of miniaturization of the microfluidics that can be achieved, is limited.

The welding of two thermoplastic material join partners by means of a galvanometer scanner by the laser transmission technique is also adequately known. Devices of this type can also be used as the closest prior art to produce weld seams with microfluidic components. A particular problem here is the positioning of the weld contour with respect to the microfluidic structure.

In this context, the use of so-called fiducial markers, which are applied to components that are to be aligned in a printing method, is known. However, the detection of purely topographical structural markers, which are not applied by a printing method and therefore do not have any contrast to the background either, is problematical. The microscopic microfluidic channels of topographical structural markers of this type, which are expressed by depressions in the surface of the lower plate, are a typical example.

### SUMMARY

The invention is now based on an object of disclosing a device for the position control of a laser machining beam relative to topographical structural markers such as are provided, for example, by the microfluidic channels realized as depressions in the lower plate surface, in which a reliable and safe recognition of the structural markers and a corresponding position control of the laser machining beam are achieved.

According to the invention, this object is achieved by an optical detection mechanism for the structural markers, which has an illumination mechanism for producing a parallel beam bundle, which illuminates the surface with the structural markers to be recognized in a scanning field, and a camera detecting the scanning field to record the reflection beam bundle reflected by the surface and changed by the structural markers. The camera image is evaluated here by the control mechanism for position recognition of the structural markers and the laser machining beam is correspondingly position-controlled.

With the aid of the device according to the invention, it is possible in an advantageous manner to detect the structural markers themselves independently of printed-on fiducial markers as such. This is also possible independently of the color of the lower component, as it is sufficient if the lower component has a certain degree of reflection. Owing to the illumination with a parallel beam bundle, the incident light beams are deflected to the side in the region of the structural markers and not reflected, which stands out in the camera image by means of corresponding darker contrasts. Using this position information with respect to the structural markers, the control can then control the laser machining beam correspondingly with respect to its position relative to the structural markers, in other words, for example, at a specific spacing along the lateral edges of the microfluidic channels, and produce a corresponding weld seam between the lower and upper plate by the laser transmission welding method. The device according to the invention, with regard to the scanning of the structural markers, is itself in a position to precisely recognize the latter even in completely transparent components and to correspondingly precisely control the laser machining beam.

According to a preferred embodiment of the device according to the invention, the parallel beam bundle of the illumination mechanism and the beam path of the camera are guided coaxially with the laser machining beam. As a result, a close association is possible between the region of the structural markers detected by the parallel beam bundles and the laser machining beam, which benefits the precision of the working results that can be achieved with the device.

If the laser machining beam is focused with the aid of a focusing mechanism onto the corresponding workpiece, it is advantageous to configure the illumination mechanism by means of a monochromatic light source with a concave lens that is adapted to the focal length of the focusing mechanism to produce a divergent beam bundle, which is then transformed by the focusing mechanism for the laser machining beam into a parallel beam bundle. The optical structure of the device is thus simplified, as the focusing mechanism for the laser machining beam is simultaneously used for the collimation of the parallel beam bundle.

The divergent beam bundle of the illumination mechanism and the beam path of the camera are preferably coupled by dichromatic mirrors into the beam path of the laser machining beam. This is a proven technique for coaxial guidance of various beam paths of individual optical components.

As known of laser machining machines per se, the focusing mechanism for the laser machining beam preferably has an F-theta optical system, which ensures a clean focusing of the laser machining beam regardless of its passage angle and position through the optical system.

Even if the device according to the invention for position control can be used in the most varied topographies, a particularly preferred configuration of the device according to the invention is its use in a laser welding mechanism for producing a weld seam between two thermoplastic material join partners in accordance with the structural markers represented, for example, by micro fluid channels in at least one of the two join partners, in other words, in particular, the lower base plate of a microfluidics system. In a device according to the invention for microfluidic components of this type, weld seams are produced along the micro fluid channels forming the structural markers by the laser transmission welding method.

The laser positioning mechanism is then formed by a galvanometer scanner, which is activated with respect to its axes by the control mechanism on the basis of corresponding control programs.

With the aid of the control mechanism, the scanner contour—in other words the track scanned by the laser machining beam to produce the weld seam—is preferably then modified in accordance with the position data of the structural markers supplied by the camera.

This modification takes place based on a conventional best-fit algorithm known per se.

To improve the optical properties of the device according to the invention, its optical components have a multiple anti-reflection coating.

Further features, details and advantages of the device according to the invention emerge from the following description of an embodiment with the aid of the accompanying drawings.

### BRIEF DESCRIPTION OF THE DRAWINGS

FIG. 1 shows a schematic diagram of a laser beam welding mechanism for microfluidic components with a device according to the invention for the position control of the laser machining beam, and

FIG. 2 shows an enlarged detailed section through a microfluidic component in the region of a depression with an associated location light intensity graph.

### DETAILED DESCRIPTION

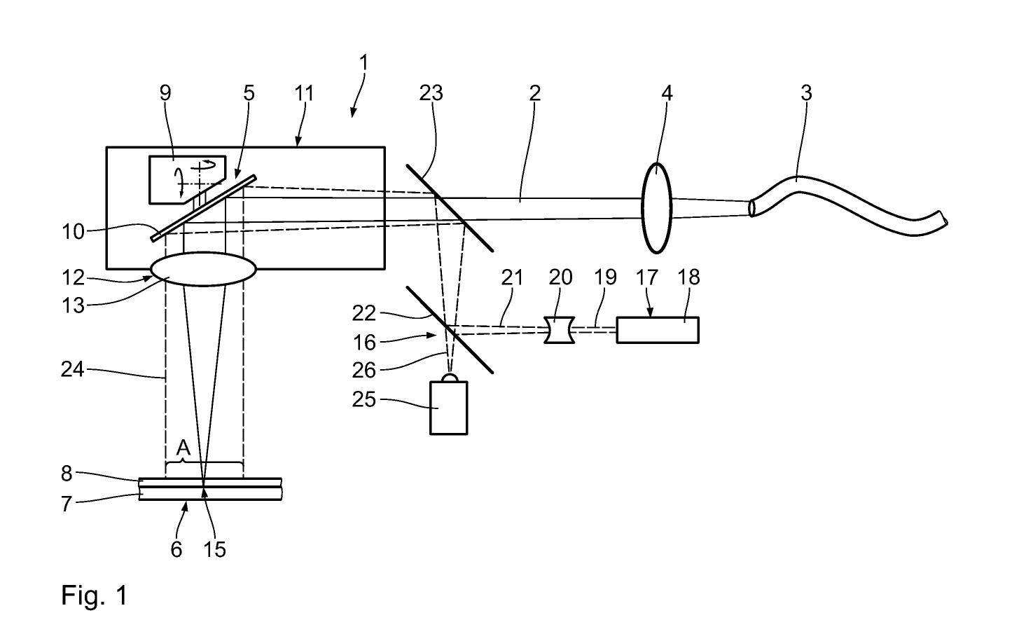

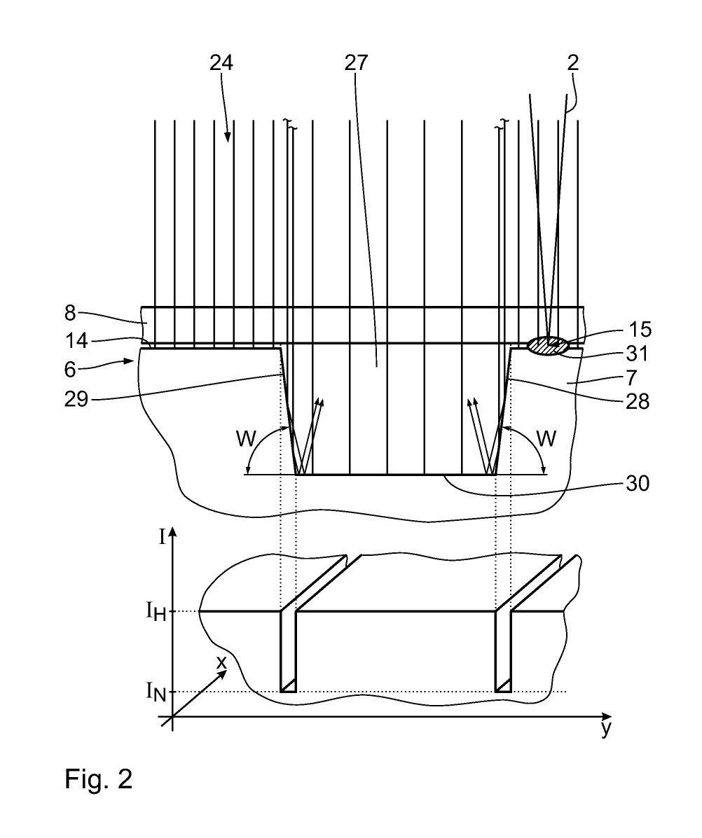

FIG. 1 shows a conventional laser transmission welding mechanism 1, in which a laser machining beam 2 is brought up with the aid of a light guide 3 from a laser source, not shown in more detail, and collimated by means of a collimation lens 4. The laser machining beam 2 is guided by means of a galvanometer scanner 5 to a microfluidics system 6 consisting of a lower base plate 7 and a cover plate 8 located thereon. The galvanometer scanner 5 in this case has a scanner mirror 10 moved by a multi-axle scanner drive 9. The scanner drive 9 is activated by a control mechanism designated 11 as a whole by means of corresponding actuators (not shown). Arranged between the galvanometer scanner 5 and the microfluidics system 6 representing the workpiece is a focusing mechanism 12 in the form of an F-theta optical system 13, with the aid of which the laser machining beam 2 is focused (focus 15) onto the microfluidics system 6 and, in particular the surface 14 of the lower base plate 7 through the laser-transparent upper cover plate 8 (see also FIG. 2 above).

For the position control of the laser machining beam 2, an optical recognition mechanism designated 16 as a whole is provided, which has an illumination mechanism 17 with a monochromatic light source, such as, for example, a light-emitting diode 18. The illumination beam 19 is converted by a concave lens 20 into a divergent light bundle 21, which, by means of a semi-permeable mirror 22 located at an angle of 45° in the beam path and a dichromatic mirror 23 arranged in the beam path of the laser machining beam 2 between the collimation lens 4 and galvanometer scanner 5 is coupled coaxially into the beam path of the laser machining beam 2. The divergent light bundle 21, like the laser machining beam 2, is guided via the scanner mirror 10 and the F-theta optical system 13. By means of a corresponding adaptation of the focal length of the concave lens 20 to the focal length of the F-theta optical system 13, the divergent light bundle 21 is converted by the latter into a collimated parallel beam bundle 24, which falls on the microfluidics system 6 in a wide scanning field A around the focus 15 of the laser machining beam 2

Provided as a further component of the optical recognition device 16 is a camera 25 seated behind the semi-permeable mirror 22, the beam path 26 of which runs after the semi-permeable mirror 22 coaxially with the light bundle 21 or parallel beam bundle 24. The region of the microfluidics system 6 illuminated by the parallel beam bundle 24 can therefore be detected with the aid of the camera 25, in that it records the light reflected back from there.

FIG. 2 illustrates the ratios in the region of a micro fluid channel 27, which is shown greatly enlarged there and is placed as a cross sectionally trapezoidal depression in the surface 14 of the lower base plate 7. For manufacturing reasons, such micro fluid channels 27 have side walls 28, 29, which are arranged at an angle W that is slightly smaller than 90° to the base face 30 of the micro fluid channel 27. The parallel beam bundle 24 is therefore not reflected back in the region of the two walls 28, 29, but deflected toward the side, so the walls 28, 29 are detected as darker, sharp lines by the camera 25 and appear black in the corresponding camera image. This can be processed as position information for the position of the micro fluid channels 27 by the control mechanism 11 and the galvanometer scanner 5 can be correspondingly activated in such a way that the focus 15 of the laser machining beam 2 can be directed just laterally outside the two walls 28, 29 on the interface between the base plate 7 and cover plate 8. A weld seam 31 can thus be produced in a conventional manner to hermetically seal the micro fluid channels 27.

The intensity distribution detected by the camera 25 is indicated in the lower diagram in FIG. 2, where a high intensity I_{H} is measured in the region of the surface 14 and the base face 30 and a low intensity I_{N} is measured, in contrast, in the region of the walls 28, 29. With an alignment of the micro fluid channel 27 parallel to the x-axis, a two-dimensional intensity distribution is then produced in the x-y plane as shown schematically at the bottom in FIG. 2.

What is claimed is:

1. A device for the position control of a laser machining beam relative to topographical structural markers in surfaces of workpieces, comprising:
a control mechanism,
a laser beam feed mechanism for providing a laser machining beam,
a laser beam positioning mechanism controlled by the control mechanism for a position control of the laser machining beam on a surface relative to the structural markers, and
an optical recognition mechanism for the structural markers with
an illumination mechanism for producing a parallel beam bundle, which illuminates the surface with the structural markers to be recognized in a scanning field, and
a camera detecting the scanning field for recording the parallel beam bundle, which is reflected by the surface and changed by the structural markers, wherein the camera image can be evaluated by the control mechanism to recognize the position of the structural markers and for the corresponding position control of the laser machining beam.

2. A device according to claim 1, wherein the parallel beam bundle of the illumination mechanism and the beam path of the camera are guided coaxially with the laser machining beam.

3. A device according to claim 2, with a focusing mechanism for the laser machining beam, wherein the illumination mechanism has a monochromatic light source with a concave lens adapted to a focal length of a focusing mechanism for producing a divergent beam bundle, which is transformed by the focusing mechanism into the parallel beam bundle.

4. A device according to claim 1, wherein the divergent beam bundle and the beam path of the camera are coupled by dichromatic mirrors into the beam path of the laser machining beam.

5. A device according to claim 2, wherein the focusing mechanism has an F-theta optical system.

6. A device according to claim 1, wherein the laser machining beam is a laser welding beam to produce a weld seam between two thermoplastic material join partners in accordance with the structural markers in at least one of the join partners.

7. A device according to claim 6, wherein the two join partners are formed by microfluidic components, between which weld seams can be produced by the laser transmission welding method along micro fluid channels forming the structural markers.

8. A device according to claim 1, wherein the laser beam positioning mechanism is formed by a galvanometer scanner.

9. A device according to claim 8, wherein the control mechanism modifies a scanner contour in accordance with position data of the structural markers supplied by the camera.

10. A device according to claim 9, wherein the modification of the scanner contour takes place on a basis of a best-fit algorithm.

11. A device according to claim 1, wherein its optical components have a multiple anti-reflection coating.

12. A device according to claim 1 for the position control of a laser machining beam relative to depressions in surfaces of workpieces.
